(19) United States
(12) Patent Application Publication
(10) Pub. No.: US 2005/0209391 A1
(43) Pub. Date: Sep. 22, 2005

(54) Transport and storage carrier of semiconductor parts containing wafer

(76) Inventors: Toshiya Nakayama, Tokyo (JP); Osamu Sugiyama, Tokyo (JP); Kiyozumi Tani, Tokushima-shi (JP)

Correspondence Address: KUBOVCIK & KUBOVCIK, SUITE 710, 900 17TH STREET NW, WASHINGTON, DC, 20006, US

(21) Appl. No.: 10/802,059

(22) Filed: Mar. 17, 2004

(51) Int. Cl. C08K 3/04

(52) U.S. Cl. 524/496

(57) ABSTRACT

A transport and storage carrier for semiconductor members including wafers which is characterized in that the carrier is molded from a resin composition comprising a synthetic resin having a melting temperature of at least 300° C. and a carbon fibril admixed with the resin, the molded carrier being 1 to 5 seconds in average charge decay time for decay of 1,000 V to 5 V.

### TECHNICAL FIELD

The present invention relates to transport and storage carriers for semiconductor members including silicon wafers and the like, such as silicon wafers, ceramic substrates, glass substrates and sapphire substrates, for use in manufacturing IC chips.

### PRIOR ART

Transport and storage wafer carriers and process wafer carriers are used, for example, for processing wafers. The latter carriers are generally immersed in liquid baths for processing wafers. Such baths contain a corrosive chemical substance and are likely to have a high temperature of 100 to 200° C. During processing, therefore, process wafer carriers must be safe not only against the chemical substance used but also against high bath temperatures. Presently in use are therefore limited only to carriers of fluorocarbon resin.

On the other hand, wafers are prone to damages due to static electricity generated by friction or contact between the wafer and the carrier when the wafer is handled or transported for processing.

For example, a transport and storage wafer carrier is known which is molded from a resin composition comprising 100 parts by weight of polyetheretherketone resin, and 5 to 100 parts by weight of a carbon fiber admixed with the resin and having an average fiber diameter of 5 to 20 μm and an average fiber length of 30 to 500 μm (the publication of JP-A No. 1998-7898).

The resin composition disclosed in the above publication contains a common carbon fiber, and use of the composition for the transport and storage wafer carrier is not desirable since if exposed to a high temperature of about 200° C., the composition evolves a gas that would cause damage to the wafer.

An object of the present invention is to provide a transport and storage carrier for semiconductor members including wafers which is 1 to 5 seconds in average charge decay time for decay of 1,000 V to 5 V and which evolves little or no gas under conditions for use.

Another object of the invention is to provide a transport and storage carrier for semiconductor members which is in the form of a molding greatly reduced in variations in charge decay time as measured at different portions thereof.

### DISCLOSURE OF THE INVENTION

The present invention provides a transport and storage carrier for semiconductor members including wafers which is characterized in that the carrier is molded from a resin composition comprising a synthetic resin having a melting temperature of at least 300° C. and a carbon fibril admixed with the resin, the molded carrier being 1 to 5 seconds in average charge decay time for decay of 1,000 V to 5 V.

The transport and storage carrier of the present invention for semiconductor members including wafers is molded from a resin composition comprising a carbon fibril in place of carbon fiber used for the conventional transport and storage wafer carrier, and a synthetic resin having a melting temperature of at least 300° C. and admixed with the fibril. We have found that the carrier is 1 to 5 seconds in average charge decay time for decay of 1,000 V to 5 V, and that the carrier is greatly diminished in the evolution of gas under conditions involving exposure to a high temperature of about 200° C.

We have further found that the molded carrier is greatly diminished in variations in charge decay time as measured at different portions thereof.

Thus, the transport and storage carrier of the invention for semiconductor members including wafers is 1 to 5 seconds in average charge decay time for decay of 1,000 V to 5 V, diminished in the evolution of gas when exposed to high temperatures, excellent in heat resistance, resistance to chemicals and moldability, and remarkably reduced in the possibility of semiconductor wafers becoming damaged during processing in any mode.

### BEST MODE OF CARRYING OUT THE INVENTION

Examples of synthetic resins usable in the present invention and having a melting temperature of at least 300° C. are polyaryletherketone, polyetheretherketone, polyethersulfone, polysulfone, polyetherimide, liquid crystal polymers, thermoplastic polyimide, polyarylate, polyethernitrile, polyphenylenesulfide, polyphenyleneether, polyamideimide, etc. Preferable among these are polyaryletherketone, polyetheretherketone, polyetherimide, polyarylate, polysulfone, liquid crystal polymers and thermoplastic polyimide. One of these synthetic resins is usable singly, or at least two of them may be used in combination when so required.

The carbon fibril to be used in the present invention is not limited particularly, but any known fibril is usable. Examples of useful carbon fibrils are superfine hollow carbon fibrils prepared by the vapor-phase growth process (process wherein particles containing a transition metal is brought into contact with CO, a hydrocarbon or like carbon-containing gas at a high temperature to produce carbon by pyrolysis, and the carbon is caused to grow into a filamentous form with the metal-containing particles serving as starting points). Preferable are carbon fibrils having an average diameter of up to 0.1 μm (100 nm) and an aspect ratio (average diameter/average thickness) of at least 5, and more preferable are those having an average diameter of 3.5 to 75 nm and an aspect ratio of 5 to 1000.

The carbon fibrils usable according to the present invention are disclosed in many patent publications including, for example, the specification of U.S. Pat. No. 4,663,230, and the publications of JP-B No. 1991-64606, JP-B No. 1991-77288, JP-A No. 1991-287821, JP-A No. 1993-125619, JP-A No. 1991-55709 (U.S. Pat. No. 3029115), JP-A No. 1991-74465 (U.S. Pat. No. 2,862,578), JP-A No. 1995-102112, JP-A No. 1990-232244, JP-A No. 1990-235945 and JP-A No. 1990-276839.

According to the present invention, commercial carbon fibrils are also usable. Examples of those commercially available are carbon nanotubes manufactured by Hyperion Catalysis International, Inc. (U.S.) and carbon nanotubes manufactured by Carbon Nanotechnologies Incorporated (U.S.).

The carbon fibril may be used in the form of a masterbatch prepared in advance. The same synthetic resin as mentioned above may be used as a synthetic resin for providing the matrix of the masterbatch. The carbon fibril content of the masterbatch is usually 5 to 50% by weight, preferably 10 to 30% by weight, although not limited specifically. Although the particle size of the masterbatch is not limited particularly either, it is usually 0.5 to 10 mm, preferably 1 to 5 mm.

The amount of carbon fibril to be used may be suitably determined from a wide range depending on the kind of the synthetic resin providing the matrix, and the dimensions of the carbon fibril, and is 1 to 10 parts by weight, preferably 3 to 8 parts by weight, per 100 parts by weight of the synthetic resin from the viewpoint that the carrier obtained is 1 to 5 seconds in average charge decay time for decay of 1,000 V to 5 V, evolves little or no gas under the conditions for use and is satisfactory in moldability and dimensional accuracy.

The resin composition to be used for the transport and storage carrier of the invention for semiconductor members including wafers can be prepared mixing and/or kneading a specified amount of the synthetic resin having a melting temperature of at least 300° C. with the carbon fibril by known means. For example, the components in the form of powders, beads, flakes or pellets are mixed and/or kneaded together using a single-screw extruder, twin-screw extruder or like extruder, or Banbury mixer, pressure kneader, twin-roll mill or like kneader to prepare pellets. Stated more specifically, pellets of the resin composition to be used for the semiconductor wafer carrier of the invention can be prepared, for example, by feeding the carbon fibril to a side hopper of a twin-screw extruder while melting the synthetic resin in the extruder, and kneading the resin and the carbon fibril in the extruder.

The transport and storage carrier of the invention for semiconductor members including wafers can be obtained by molding the resin composition by a known resin molding process, such as injection molding, compression molding or extrusion. The carrier of the invention can be obtained, for example, by injection molding using a mold which is made based on the properties, such as shrinkage factor and melt flow rate, of the resin composition of the invention and setting the molding conditions such as the cylinder temperature, mold temperature, injection pressure and injection speed.

The transport and storage carrier for semiconductor members including wafers is not particularly limited in shape; the carrier may be of any known shape insofar as it is so shaped as to protect semiconductor wafers as arranged at a given spacing. For example, the carrier may be in the shape of a basket or an open cassette.

### BRIEF DESCRIPTION OF THE DRAWINGS

FIG. 1 is a plan view of a test piece showing charge decay time measuring sites.

FIG. 2 is a graph showing the relationship between the measuring site of the test piece and the charge decay time.

FIG. 3 is a view showing a wafer basket.

### EXAMPLES

The present invention will be described below in greater detail with reference to Examples, Comparative Examples and Test Examples.

The details of the synthetic resins and fillers used in Examples are as follows.
Polyetherimide [trade name: ULTEM #1010-1000]
Polyetheretherketone [trade name: VICTREX 151G, product of Victrex-MC Co., Ltd., hereinafter referred to briefly as “PEEK-1”]
Polyetheretherketone [trade name: VICTREX 450G, product of Victrex-MC Co., Ltd., hereinafter referred to briefly as “PEEK-2”]
Carbon fibril [trade name: GRAPHITE FIBRIL, 15 nm in average outside diameter, 5 nm in average inside diameter, 0.2 to 20 μm in length, product of Hyperion Catalysis International, Inc., hereinafter referred to briefly as “HP”]
Carbon fiber [trade name: DIALEAD K223NM, 10 μm in average fiber diameter, 6 mm in average fiber length, product of Mitsubishi Chemical Functional Products, Inc., hereinafter referred to briefly as “CF”]
Carbon black [trade name: KETJEN EC 600JD]

### EXAMPLE 1

Polyetheretherketone (PEEK-1, 95 parts by weight) was placed into the main hopper of a twin-screw extruder, melted and kneaded, and 5 parts by weight of a carbon fibril (HP) was thereafter added to the resin through the side feeder. The mixture was kneaded in a molten state and extruded to prepare pellets.

### EXAMPLE 2

Pellets were prepared in the same manner as in Example 1 with the exception of using 93 parts by weight of polyetheretherketone (PEEK-2) in place of 95 parts by weight of polyetheretherketone (PEEK-1) and using 7 parts by weight of the carbon fibril (HP) in place of 5 parts by weight thereof.

### EXAMPLE 3

Pellets were prepared in the same manner as in Example 1 with the exception of using 96 parts by weight of polyetherimide (PEI) in place of 95 parts by weight of polyetheretherketone (PEEK-1) and using 4 parts by weight of the carbon fibril (HP) in place of 5 parts by weight thereof.

### COMPARATIVE EXAMPLE 1

Comparative pellets were prepared in the same manner as in Example 1 with the exception of using carbon fiber (CF) in place of the carbon fibril (HP).

### COMPARATIVE EXAMPLE 2

Comparative pellets were prepared in the same manner as in Example 1 with the exception of using carbon black (CB) in place of the carbon fibril (HP).

### TEST EXAMPLE 1

The pelletized composition of each of Examples and Comparative Examples was placed into an injection molding machine [trade name: J75SSII-A, product of The Japan Steel Works, LTD., cylinder temperature: 350 to 360° C.] equipped with a JIS test piece making mold (mold temperature: 140° C.) for injection molding to prepare various JIS test pieces, which were tested for the following properties. Table 1 shows the results.

(1) Surface resistivity value (Ω) and volume resistivity value (Ω·m): measured according to JIS K6911. These are properties indicative of electrical conductivity.

(2) Tensile strength (MPa) and tensile elongation at break (%): measured according to JIS K7113.

(3) Flexural strength (MPa) and flexural modulus (GPa): measured according to JIS K7171.

(4) Notched Izod impact value (J/m): evaluated with reference to No. 1 test pieces according to JIS K7110.

(2) to (4) are properties indicative of mechanical strength.

TABLE 1

| | Example | | | Comp. Ex. | |
|---|---|---|---|---|---|
| | 1 | 2 | 3 | 1 | 2 |
| Synthetic | PEEK | PEEK | PEI | PEEK | PEEK |
| resin | | | | | |
| Conductive | HP | HP | HP | CF | CB |
| Material | | | | | |
| Surface | 3.E+07 | 3.E+05 | 5.E+05 | 1.E+05 | 1.E+09 |
| resistivity | | | | | |
| value Ω | | | | | |
| Volume | 6.E+07 | 1.E+04 | 1.E+03 | 1.E+04 | 1.E+08 |
| resistivity | | | | | |
| value | | | | | |
| Ω · m | | | | | |
| Tensile | 100 | 98 | 112 | 139 | 91 |
| strength | | | | | |
| MPa | | | | | |
| Tensile | 4.5 | 3.7 | 9.5 | 2.1 | 3.3 |
| elongation | | | | | |
| at break % | | | | | |
| Flexural | 147 | 151 | 152 | 190 | 144 |
| strength | | | | | |
| MPa | | | | | |
| Flexural | 3.7 | 3.8 | 3.3 | 10.6 | 3.8 |
| modulus | | | | | |
| GPa | | | | | |
| Izod J/m | 29 | 26 | 41 | 47 | 25 |

### TEST EXAMPLE 2

(1) Abrasion Resistance Test A [Abrasion Wear (mg/mm²)]

The pelletized composition prepared in each of Examples and Comparative Examples was made into abrasion test pieces (hollow tubes measuring 25.6 mm in outside diameter, 20 mm in inside diameter, 15 mm in height) by an injection molding operation conducted under the conditions of: molding temperature 350 to 360° C., injection pressure (primary pressure) 1200 kgf/cm², dwell pressure (secondary pressure) 500 kgf/cm², and injection-dwell time 20 sec. The test pieces were tested for abrasion wear (mg/mm²) using a Suzuki Abrasion Tester [product of Orientec Corporation] under the conditions of: counterpart S45C (medium carbon steel), frictional surface pressure 1.2 kgf/cm², friction velocity 30 cm/sec, and running time 1 hour.

(2) Abrasion Resistance Test B [Depth of Wear (μm)]

Abrasion test pieces, measuring 90×50×3.2 mm, were prepared in the same manner as the abrasion resistance test A. A 1-mm-thick glass plate was placed vertically on the test piece and reciprocatingly moved 5000 times at a speed of 300 mm/sec over a distance of 4 cm with a load of 718 g/cm² applied to the glass plate using a reciprocating slide tester. The test piece was thereafter checked for the depth of wear (μm) using a surface roughness meter [trade name; SURFCOM 300B, product of Tokyo Seimitsu Co., Ltd.]

Table 2 shows the results.

TABLE 2

| | |
|---|---|
| Abrasion wear (mg) | Depth of wear |

| | Test piece | Counterpart | (μm) |
|---|---|---|---|
| Example 1 | 0 | 0 | 0 |
| Example 2 | 1 | 0 | 0 |
| Example 3 | 2 | 0 | 0 |
| Comp. Ex. 1 | 5 | 2 | 10 |
| Comp. Ex. 2 | 8 | 1 | 10 |

Table 2 reveals that the moldings of the present invention have satisfactory abrasion resistance and are exceedingly superior to the moldings of Comparative Examples especially with respect to the depth of wear.

### TEST EXAMPLE 3

One gram of the material prepared in each of Example 1 and Comparative Example 1 was placed into a head-space vial, which was then sealed off with a septum (closure) and thereafter set in an autosampler. The sample was analyzed by a gas chromatograph (Tekmer 7050/GL Science GC353/SIC Labchart 180) equipped with a head-space pretreating device under the following conditions to measure the amount of gas evolved. Example 1 gave a measurement of 43,000 area/g, while Comparative Example 1 gave a measurement approximately twice this value, i.e., 85,000 area/g. This indicates that the molding of the invention is diminished in the evolution of gas at high temperatures.
Temperature of the sample: 180° C.×20 min
Column: TC-WAX 0.53×30000 mm
Temperature of the column: 40° C. (10 min)→10° C./min→200° C. (5 min)
Detector: FID
Detecting temperature: 240° C.

### TEST EXAMPLE 4

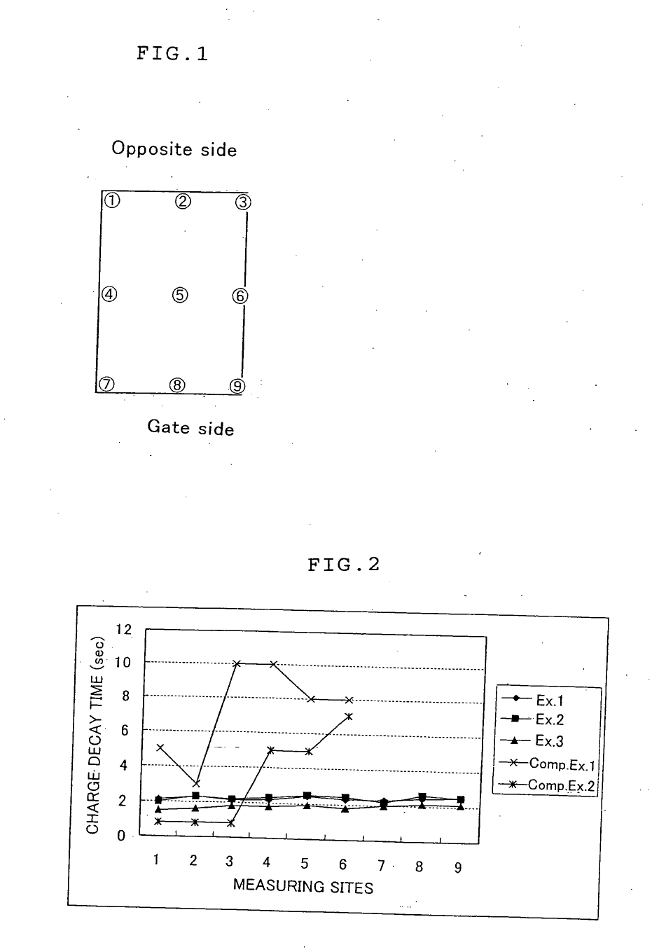

The pelletized composition obtained in each of Examples and Comparative Examples was molded by an injection molding machine to prepare test pieces measuring 90×50×3.2 mm. The portions \mathring{1} to \mathring{9} shown in FIG. 1 of the test piece obtained were checked for charge decay time by a measuring instrument (charged plate monitor). FIG. 2 shows the results.

The voltage failed to decrease to 5 V at the measuring sites \mathring{7} to \mathring{9} of the test pieces of Comparative Examples 1 and 2.

FIG. 2 reveals that the moldings of the present invention are 1 to 5 seconds in average decay time for decay of 1000 V to 5 V, and are greatly diminished in variations of measurements at different measuring sites although excessively rapid decay of charge will cause trouble to wafers and is not acceptable.

### TEST EXAMPLE 5

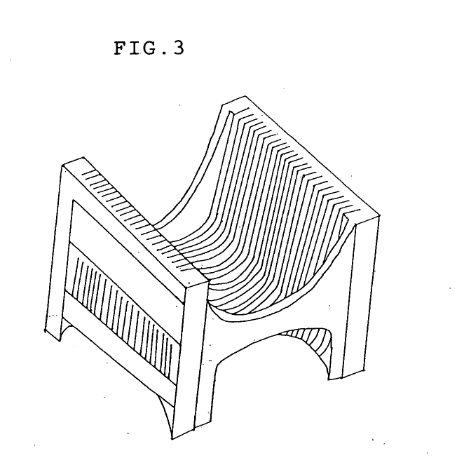

The pelletized composition obtained in each of Example 1 and Comparative Example 2 was molded by an injection molding machine into a wafer basket as shown in FIG. 3. The wafer basket was immersed in pure water, and washed by an ultrasonic cleaning device at 40 kHz for 8 minutes. The washing liquid was thereafter checked for the number of particles therein using a particle counter. The same molding was tested in the same manner as above eight times using fresh pure water, the washing liquids resulting from the second to eighth procedures were each checked for particle count, and the counts were added up to obtain a total count. Table 3 shows the results.

TABLE 3

| | Example 1 | Comp. Ex. 2 |
|---|---|---|
| Conductive material | HP | CF |
| Particle count | 4,027 | 35,333 |

Table 3 shows that the transport and storage carrier of the present invention for semiconductor members including wafers is diminished in the number of particles released into the washing liquid. This reveals that the carrier is also exceedingly superior also in resistance to washing to the one made from other material containing a carbon fiber.

### EFFECTS OF THE INVENTION

The transport and storage carrier of the invention for semiconductor members including wafers is molded from a resin composition comprising a synthetic resin at least 300° C. in melting temperature and a carbon fibril admixed with the resin. The carrier is 1 to 5 seconds in average charge decay time for decay of 1,000 V to 5 V, and sufficiently diminished in the evolution of gas even under conditions involving exposure to a high temperature of about 200° C. Moreover, when checked for charge decay time, the molded carrier is found to have the feature that it is greatly reduced in variations of measurements at different portions thereof.

The transport and storage carrier of the invention for semiconductor members including wafers is also decreased in the number of particles released into the washing liquid, hence very high resistance to washing.

1. A transport and storage carrier for semiconductor members including wafers which is characterized in that the carrier is molded from a resin composition comprising a synthetic resin having a melting temperature of at least 300° C. and a carbon fibril admixed with the resin, the molded carrier being 1 to 5 seconds in average charge decay time for decay of 1,000 V to 5 V.

2. A carrier according to claim 1 wherein the synthetic resin is polyetheretherketone, polyetherimide or polyethersulfone.

3. A carrier according to claim 1 wherein the carbon fibril is 3.5 to 75 nm in average diameter and 5 to 1000 in aspect ratio.

4. A carrier according to claim 1 wherein 1 to 10 parts by weight of the carbon fibril is used per 100 parts by weight of the synthetic resin.
